(19) United States
(12) Patent Application Publication
(10) Pub. No.: US 2026/0119723 A1
(43) Pub. Date: Apr. 30, 2026

(54) UPDATE MANIFEST CERTIFICATES

(71) Applicant: HEWLETT PACKARD ENTERPRISE DEVELOPMENT LP, Spring, TX (US)

(72) Inventors: Dilip Kumar Ramakrishna Reddy, Bangalore (IN); Shiva R. Dasari, Austin, TX (US); Kenneth John Geer, Aurburn, CA (US); Stephen Barnett Lyle, Granite Bay, CA (US); Luis E. Luciani, Jr., Tomball, TX (US)

(21) Appl. No.: 18/932,710

(22) Filed: Oct. 31, 2024

(51) Int. Cl. G06F 21/73; G06F 9/4401

(52) U.S. Cl. CPC G06F 21/73; G06F 9/4401

(57) ABSTRACT

In some examples, during a startup of the computer system, a controller performs a validation of components in a chain of trust of the computer system, and a validation of a manifest certificate for the computer system. Based on the validations of the components and the manifest certificate, the controller obtains information of a hardware or program component of the computer system. The controller includes the obtained information of the hardware or program component in an update manifest certificate. The controller obtains a signed version of the update manifest certificate, and stores the signed version of the update manifest certificate in a storage repository for establishing a trustworthiness of the computer system.

### BACKGROUND

A computer system can include various components, including hardware components and program components. Hardware components can include electronic components such as a central processing unit (CPU), a network interface controller, a graphics controller, an accelerator, an input/output (I/O) device, a memory device, a storage device, or any other electronic component. Program components can include system firmware, an operating system (OS), an application program, or other machine-readable instructions.

### BRIEF DESCRIPTION OF THE DRAWINGS

Some implementations of the present disclosure are described with respect to the following figures.

FIG. 1 is a block diagram of an arrangement including a computer system, a system update enterprise device, and an operations management system, according to some examples.

FIG. 2 is a flow diagram of a process of a system including a management controller and system firmware, according to some examples.

FIG. 3 is a block diagram of a storage medium storing machine-readable instructions according to some examples.

FIG. 4 is a block diagram of a computer system according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A manifest certificate may be created for a computer system during manufacture for use in detecting any unauthorized changes to the computer system after the computer system is shipped from a manufacturing facility. An example of the manifest certificate is a platform certificate, as described by the Trusted Computing Group (TCG) Platform Certificate Profile Specification. A platform certificate is an X.509 attribute certificate signed by a certificate authority (CA) of a manufacturer of a computer system. The platform certificate includes a manifest of components of the computer system. In some examples, the platform certificate is bound to a security processor (also referred to as a security cryptoprocessor) of the computer system, where the security processor can perform various hardware-based, security functions in the computer system, including key management and generation of cryptographic keys used in security operations. An example of a security processor is a trusted platform module (TPM).

In some cases, changes of computer systems may be allowed after the computer systems have left respective manufacturing facilities. The changes may be performed by value-added resellers (VARs), system integrators, customers of the computer systems, or other system update enterprises (companies, organizations, individuals, etc.). A system update enterprise may add or change hardware components or program components (e.g., firmware or software components), for example, of computer systems. Such a modification of a computer system made by a system update enterprise is considered an authorized modification. As a result of the authorized modification of a computer system, a platform certificate provided by a manufacturer of the computer system becomes out of date and is inconsistent with the actual components of the computer system. In some cases, it may be possible for a system update enterprise to issue an update platform certificate to reflect an authorized modification of a computer system.

According to the TCG Platform Certificate Profile Specification, the update platform certificate may be a delta platform certificate or a rebase platform certificate. However, to issue the update platform certificate, the system update enterprise would have to employ a signing infrastructure, e.g., a certificate authority (CA) infrastructure, which has the ability to generate keys and sign certificates. Some system update enterprises may not deploy signing infrastructures due to the cost or complexity of the signing infrastructures. As a result, such system update enterprises would not be able to securely issue update platform certificates to reflect authorized modifications of computer systems. In addition, even though they may possess signing infrastructures, some system update enterprises may prefer a simplified way of modifying components of computer systems that do not involve the system update enterprises having to issue update certificates.

In accordance with some examples of the present disclosure, a management controller of a computer system is used to produce an update manifest certificate associated with modifying the computer system after the computer system has left a facility of a source (e.g., a manufacturer or other source) of the computer system. By using the management controller to produce the update manifest certificate, a system update enterprise (different from the source of the computer system) that performs the modification of the computer system does not have to use a separate signing infrastructure to create the update manifest certificate. In some examples of the present disclosure, during a startup of the computer system, the management controller performs a validation of components in a chain of trust of the computer system, and a validation of a manifest certificate for the computer system, where the manifest certificate was produced by the source of the computer system. Based on the validation of the components and the manifest certificate, the management controller obtains information of hardware and program components of the computer system, and the management controller includes the obtained information of the hardware and program components in an update manifest certificate. The management controller obtains a signed version of the update manifest certificate, and stores the signed version of the update manifest certificate in a storage repository for establishing a trustworthiness of the computer system. The management controller can obtain the signed version of the update manifest certificate in one of the following ways: (1) the management controller can itself sign the update manifest certificate, or (2) the management controller can request a remote entity sign the update manifest certificate.

The update manifest certificate generated by the management controller of the computer system can be used to verify that updates of components by a system update enterprise are authorized (i.e., not made by an unauthorized entity). This allows any unauthorized updates of the computer system to be detected so that security breaches can be avoided.

As used here, a “manifest certificate” can refer to any data structure that contains information of properties of a computer system, including information relating to hardware and program components of the computer system. The manifest certificate can also include information relating to a cryptographic anchor that can be used to verify an integrity of the manifest certificate. In some examples, the cryptographic anchor can be a security processor such as a TPM.

An example of a manifest certificate is a platform certificate according to the TCG Platform Certificate Profile Specification. The platform certificate produced by a source (e.g., a manufacturer or other source) of the computer system is referred to as a base platform certificate. In such examples, an update manifest certificate can refer to a delta platform certificate or a rebase platform certificate.

Although reference is made to platform certificates as examples of manifest certificates, in other examples, other types of manifest certificates can be employed, such as manifest certificates established by other standards, manifest certificates defined by open-source protocols, or proprietary manifest certificates.

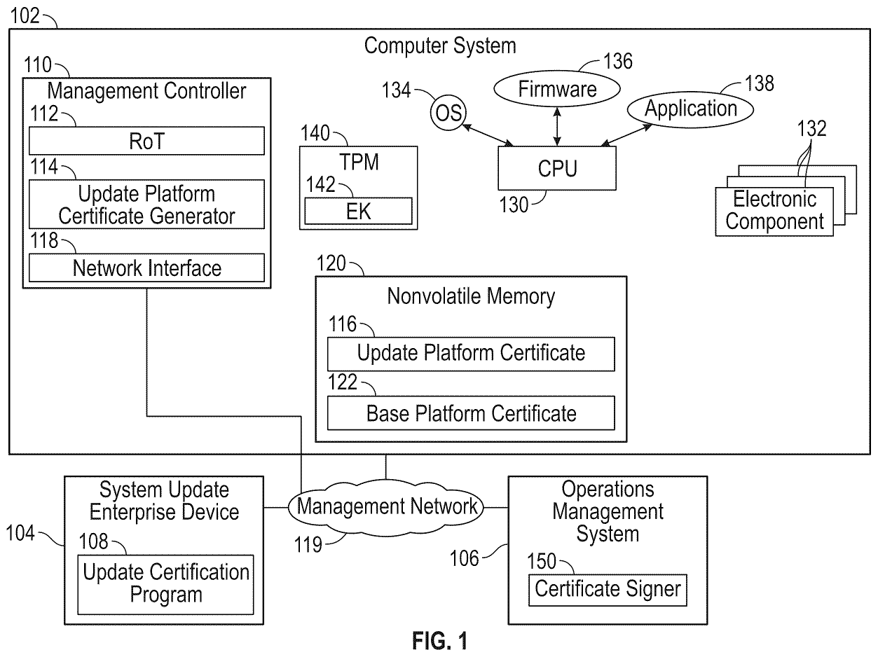

FIG. 1 is a block diagram of an example arrangement including a computer system 102, a system update enterprise device 104, and an operations management system 106. In other examples, the operations management system 106 may be omitted.

The system update enterprise device 104 is an electronic device associated with a system update enterprise, such as a VAR, system integrator, or customer that has updated components in the computer system 102. Updating the components in the computer system 102 can refer to adding a component, removing a component, or changing a configuration of the component. The component that is updated can include a hardware component or a program component.

The system update enterprise device 104 can be used by a user of the system update enterprise to initiate the creation of an update platform certificate according to some examples of the present disclosure. The created update platform certificate reflects updated component(s) of the computer system 102. In accordance with some examples of the present disclosure, the creation of the update platform certificate is performed by a management controller 110 in the computer system 102.

The system update enterprise device 104 includes an update certification program 108, which can be invoked by the user to initiate the generation of the update platform certificate. For example, the update certification program 108 can present a user interface (UI) through which the user can submit commands to the computer system 102, and more specifically, to the management controller 110 in the computer system 102, to begin the process of generating an update platform certificate. The UI presented by the update certification program 108 can include a graphical user interface (GUI), a command line interface (CLI), or another type of interface.

The management controller 110 in the computer system 102 is used to perform various management actions in the computer system 102. An example of the management controller 110 is a baseboard management controller (BMC). In other examples, other types of management controllers can be employed.

The management controller 110 includes a RoT 112, such as a hardware root of trust (HWRoT), which is also referred to as a Silicon Root of Trust (SRoT). The RoT 112 includes a trust mechanism in the management controller 110 that is used to validate information (e.g., machine-readable instructions such as firmware and/or software to be executed on the management controller 110, configuration information, security information, and/or other information) of the management controller 110 prior to execution of the management controller 110.

For example, when the computer system 102 initially starts (such as due to powering on from a lower power state or an off state, a reboot, a reset, etc.), the RoT 112 performs a measurement of the information of the management controller 110, and uses a value (e.g., a cryptographic hash value) produced by the measurement to perform a validation of the information of the management controller 110. If the RoT 112 does not successfully validate the information of the management controller 110, then further execution of the management controller 110 is stopped as the management controller 110 may be compromised. However, if the RoT 112 successfully validates the information of the management controller 110, the management controller 110 is allowed to continue with further operations.

The management controller 110 includes an update platform certificate generator 114, which is used to generate an update platform certificate 116. The update platform certificate generator 114 can be implemented using a portion of the hardware processing circuitry of the management controller 110, or alternatively, can be implemented using machine-readable instructions executed by the management controller 110.

The management controller 110 further includes a network interface 118 that allows the management controller 110 to communicate over a network with other devices or systems. For example, the network interface 118 can be connected to a management network 119. The system update enterprise device 104 and the operations management system 106 are able to communicate with the management controller 110 over the management network 119.

In some examples, after components of the computer system 102 have been updated by a system update enterprise, the system update enterprise device 104 can be used to send a request to the management controller 110 over the management network 119 for creating the update platform certificate 116. In some examples, the request can be in the form of a Redfish call according to the Redfish standard from the Distributed Management Task Force (DMTF), which supports the management of devices such as server computers, storage systems, networking equipment, or other devices. In other examples, the request to create the update platform certificate 116 can be issued using another interface, such as a REpresentational State Transfer (REST) application programming interface (API), or any other type of interface through which an entity external of the management controller 110 can communicate with the management controller 110.

To ensure that a user of the system update enterprise device 104 is in fact authorized to initiate the creation of the update platform certificate 116, the update certification program 108 in the system update enterprise device 104 or the update platform certificate generator 114 in the management controller 110 can authenticate the user. The authentication can be based on credentials presented by the user, for example, where the credentials can include a username and password or other credentials. If the user is not authenticated, then the request to create the update platform certificate 116 can be denied.

The update platform certificate 116 generated by the update platform certificate generator 114 is stored in a nonvolatile memory 120. The nonvolatile memory 120 is a memory that can maintain its stored content even if power is removed from the nonvolatile memory 120. The nonvolatile memory 120 also stores a base platform certificate 122, which is the platform certificate created by the source of the computer system 102 representing components of the computer system 102 prior to the update of the computer system 102 performed by the system update enterprise.

Although FIG. 1 shows the update platform certificate 116 and the base platform certificate 122 stored in the nonvolatile memory 120, in other examples, the update platform certificate 116 and the base platform certificate 122 may be stored in other storage repositories, whether inside or outside the computer system 102. A storage repository can be implemented with one or more storage devices.

The base platform certificate 122 includes information (an assertion) of properties and the configuration of components of the computer system 102 as shipped by the source (e.g., manufacturer) of the computer system 102. The base platform certificate 122 does not reference any other platform certificate for the computer system 102. In some examples, the properties of components specified in the base platform certificate 122 can include any or some combination of the following: identifiers (e.g., serial numbers or other unique identifiers of the components), other information (e.g., model numbers, version information, manufacturer names, etc.) of the components, a network address of a network adapter (e.g., a Media Access Control (MAC) address), or other properties. Configuration information included in the base platform certificate 122 can include configuration settings of the components, for example.

The update platform certificate 116 can be a delta platform certificate or a rebase platform certificate. The delta platform certificate includes information (an assertion) about specific updates made to a platform, such as the computer system 102, where the specific updates are not reflected in an existing platform certificate, such as the base platform certificate 122 and any other update platform certificate(s). The delta platform certificate references a previously-issued base platform certificate or another delta platform certificate. If components are added to the computer system 102 or existing components of the computer system 102 are modified, the delta platform certificate can include information of the added or modified components. If existing components are removed from the computer system 102, the delta platform certificate includes information referring to the removed components.

A rebase platform certificate is functionally equivalent to a base platform certificate in that the rebase platform certificate is a self-contained platform certificate that contains the complete set of assertions specified by its issuer (e.g., the rebase platform certificate includes information of all components in the computer system 102, including components that were not updated). In addition, the rebase platform certificate references a previously-issued platform certificate (either a base or a delta platform certificate).

The reference made by an update platform certificate to another platform certificate provides a linkage between the platform certificates. Providing information of such linkage allows an entity that seeks to verify the authenticity of a platform, such as the computer system 102, visibility into an entire chain of custody of the platform, including the manufacturer and any system update enterprise(s) that may have made changes to the platform.

The computer system 102 includes various components, including a CPU 130 and various electronic components 132, such as accelerators, network adapters, graphics controllers, input/output (I/O) devices, memory devices, and so forth. The computer system 102 also includes program components, including an OS 134, system firmware 136, and an application program 138. The CPU 130 executes primary machine-readable instructions of the computer system 102, such as the OS 134, the system firmware 136, and the application program 138. The system firmware can include Basic Input/Output System (BIOS) code or Universal Extensible Firmware Interface (UEFI) code. The CPU 130 can include one or more hardware processors.

The computer system also includes a trusted platform module (TPM) 140. The TPM 140 performs hardware-based security functions in the computer system 102, including key management and generation of cryptographic keys used in security operations. An example of a cryptographic key includes an endorsement key (EK) 142 stored in a secure memory of the TPM 140. The TPM 140 has physical security mechanisms that protect the TPM 140 against unauthorized access, such as access by malicious programs.

The EK 142 was created by a manufacturer of the TPM 140 from a seed stored in the secure memory of the TPM 140 at the time of manufacture of the TPM 140. The EK 142 is unique to the TPM 140. In some examples, the TPM 140 constitutes a cryptographic anchor of the computer system 102, and the EK 142 in the TPM 140 constitutes information that relates to the cryptographic anchor. The EK 142 is used to perform a binding check to ensure that the a platform certificate is bound to the TPM 140.

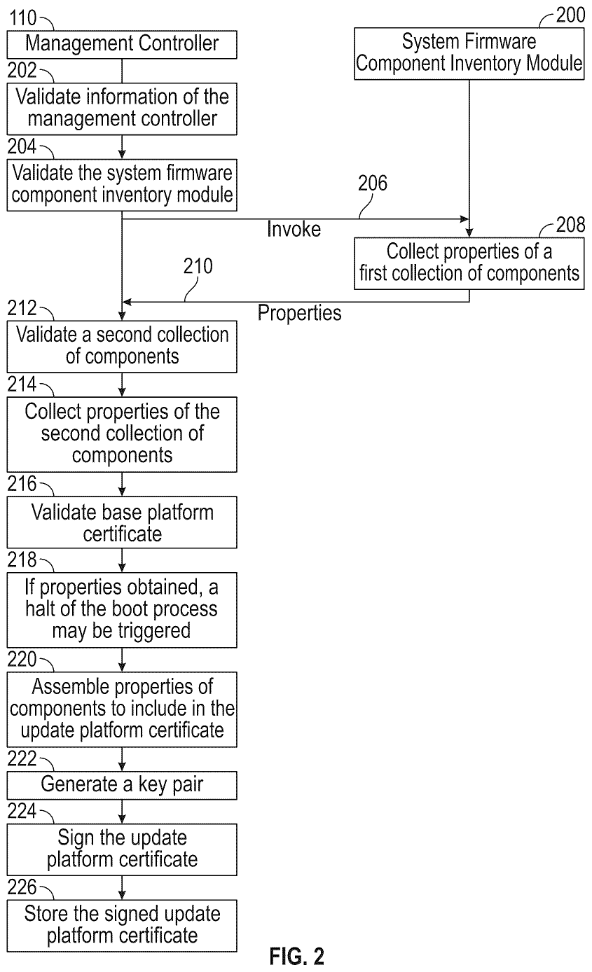

FIG. 2 is a flow diagram of a process of generating an update platform certificate, such as 116 in FIG. 1. The process of FIG. 2 may be initiated in response to a request from the update certification program 108 of the system update enterprise device 104 of FIG. 1. Although not shown in FIG. 2, at some point in the process, to ensure that a user of the system update enterprise device 104 is in fact authorized to initiate the creation of the update platform certificate 116, the update certification program 108 in the system update enterprise device 104 or the update platform certificate generator 114 in the management controller 110 can authenticate the user.

The request to generate an update platform certificate may cause the management controller 110 to initiate a reboot of the computer system 102. As part of the boot process following the reboot, the RoT 112 validates (at 202) information (e.g., one or more firmware modules) of the management controller 110. In response to the RoT 112 successfully validating the information of the management controller 110, the management controller 110 validates (at 204) a portion of system firmware, e.g., UEFI code, that is to be used to collect properties of a first collection of components of the computer system 102. The collected properties are for building the content of the update platform certificate 116. The portion of the system firmware to be used for collecting properties of the first collection of components is referred to as a “system firmware component inventory module,” which is depicted as 200 in FIG. 2. Note that the system firmware may include one or more other modules to perform other boot tasks (e.g., loading the OS 134) during the boot process of the computer system 102.

If the system firmware component inventory module 200 is not validated, the process stops. If the system firmware component inventory module 200 is validated, the update platform certificate generator 114 of the management controller 110 invokes (at 206) the system firmware component inventory module 200 for collecting (at 208) the properties of the first collection of components. The collected properties can include identifiers of the first collection of components, other information (e.g., model numbers, version information, manufacturer names, etc.) of the first collection of components, a network address of a network adapter, configuration settings of the components, and other properties. The system firmware component inventory module 200 is invoked by the management controller 110 since the management controller 110 may not have access to some components in the computer system 102. For example, the management controller 110 may not have access to a Peripheral Component Interconnect (PCIe) device, the TPM 140, or a storage drive of the computer system 102, as examples. The system firmware component inventory module 200 sends (at 210) the collected properties of the first collection of components to the management controller 110.

The management controller 110 also validates (at 212) other components (a second collection of components) of the computer system 102 that the management controller 110 is able to access. Examples of the second collection of components accessible by the management controller 110 include the CPU 130, program components such as the OS 134, the system firmware 136, and the application program 138, and some of the electronic components 132. If the second collection of components is not validated, the process stops. In response to validating the second collection of components, the update platform certificate generator 114 of the management controller 110 collects (at 214) properties of the second collection of components.

In alternative examples, the management controller 110 does not have to rely on the system firmware 136 to collect properties of the first collection of components. In such alternative examples, the management controller 110 has access to all components of the computer system 102 for which properties are to be collected for building the update platform certificate 116.

The validation of a component by the management controller 110 (e.g., a module of the system firmware 136 or a component of the second collection of components) is based on a integrity measurement of the component. For example, the management controller 110 can issue a request to obtain a measurement, such as a GET_MEASUREMENTS request according to the DMTF Security Protocols and Data Models (SPDM) standard. The SPDM standard enables authentication, attestation, and key exchange to assist in providing infrastructure security.

The GET_MEASUREMENTS request is issued to a responder, which in this case is a component to be validated by the management controller 110. Examples of measurements can include hash values derived from applying cryptographic hash functions on information of components.

The management controller 110 compares the requested measurement of each component with a respective reference integrity measurement (a golden measurement or expected measurement) for the component. If the measurements match, then the component is validated.

The update platform certificate generator 114 of the management controller 110 also validates (at 216) the base platform certificate 122 to ensure that the base platform certificate 122 is bound to the TPM 140. This check is to ensure that the base platform certificate 122 belongs to the computer system 102. The base platform certificate 122 has information about the EK 142 in the TPM 140. The information about the EK 142 in the base platform certificate 122 may be the EK itself, or information that can be used to retrieve the EK.

The update platform certificate generator 114 checks that the base platform certificate 122 is signed by the source (e.g., manufacturer) of the computer system 102. The update platform certificate generator 114 also looks for and extracts the EK from the base platform certificate 122, and compares the EK of the base platform certificate 122 to the EK 142 in the TPM 140. If the EKs match, then the base platform certificate 122 is bound to the TPM 140, and the base platform certificate 122 is valid. If the base platform certificate 122 is not validated, the process stops.

If the platform certificate generator 114 determines that the properties of the components that are to be used in populating the update platform certificate 116 are obtained, the platform certificate generator 114 may trigger a halt (at 218) of any further operations in the computer system 102. For example, the platform certificate generator 114 can issue an indication to the management controller 110 to cause the boot process of the computer system 102 to halt. For example, in response to receiving the properties of the first collection of components from the system firmware component inventory module, the platform certificate generator 114 can cause the management controller 110 to stop any further module(s) of the system firmware 136 from loading.

Halting the boot process reduces the amount of code run in the computer system 102, which reduces the attack surface that an attacker (e.g., malware or another type of attacker) can compromise.

The platform certificate generator 114 assembles (at 220) the properties of components that are to be included in the update platform certificate 116. If the update platform certificate 116 is a delta platform certificate, the assembling of the properties of the components can include making a determination of which components have been updated. This determination can be based on comparing the properties of components collected (at 208 and 214), and comparing the collected properties to properties of components included in the base platform certificate 122. Based on this comparison, the platform certificate generator 114 can identify which components have been updated. The platform certificate generator 114 includes properties of the updated components in the delta platform certificate. Properties of components not updated are not added to the delta platform certificate.

However, if the update platform certificate 116 is a rebase platform certificate, then the collected properties of all components would be added to the rebase platform certificate. In either case, the platform certificate generator 114 adds information of the EK 142 to the update platform certificate 116, to bind the update platform certificate 116 to the TPM 140.

The update platform certificate generator 114 generates (at 222) a key pair that includes a public key and the corresponding private key. For example, the generated key pair can be according to the Rivest-Shamir-Adleman (RSA) algorithm. The private key may be stored in the TPM 140 to protect the private key from unauthorized access.

In some examples, the update platform certificate generator 114 signs (at 224) the update platform certificate 116 using the private key. In other examples, the update platform certificate generator 114 can request that the operations management system 106 (FIG. 1) sign the update platform certificate 116. In the latter examples, the operations management system 106 includes a certificate signer 150 that can generate a key pair and use the private key of the key pair to sign the update platform certificate 116. The management controller 110 can send the update platform certificate 116 to the operations management system 106 in a secure communications session, such as a Transport Layer Security (TLS) session or another type of secure communications session.

The certificate signer 150 in the operations management system 106 signs the update platform certificate 116 with the private key. The operations management system 106 sends, in the secure communications session, the signed update platform certificate 116 along with the public key of the key pair to the management controller 110.

The update platform certificate generator 114 stores (at 226) the signed update platform certificate 116 in the nonvolatile memory 120. The public key of the key pair can be made available to a customer of the computer system 102 for use in decrypting the signed update platform certificate 116 for the purpose of checking that updates of components in the computer system 102 are authorized.

In some examples, the signed update platform certificate 116 can be stored in the same storage location (e.g., at a location referenced by a uniform resource locator or URL, in a directory of a filesystem, etc.) as the base platform certificate 122 so that a verification tool for authorizing the updates of the components in the computer system 102 can easily find the signed update platform certificate 116. The verification tool can also extract information of the EK 142 from the update platform certificate 116 after decryption, and can verify that the update platform certificate 116 is bound to the TPM 140 of the computer system 102. This check ensures that the update platform certificate 116 has not been tampered with.

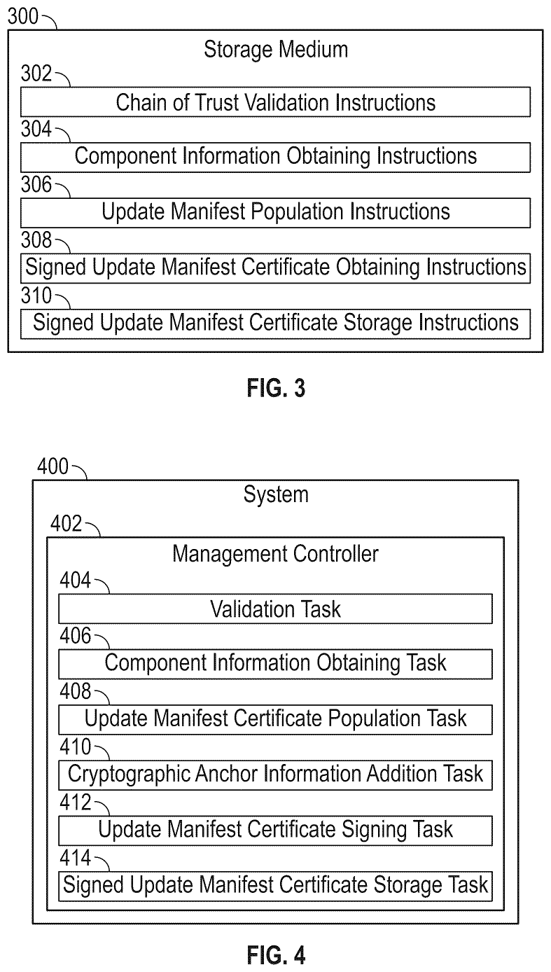

FIG. 3 is a block diagram of a non-transitory machine-readable or computer-readable storage medium 300 storing machine-readable instructions that upon execution cause a controller of a computer system to perform various tasks. An example of the controller is the management controller 110 of FIG. 1.

The machine-readable instructions include chain of trust validation instructions 302 to, during a startup of the computer system, perform a validation of components in a chain of trust of the computer system, and a validation of a manifest certificate for the computer system. The components in the chain of trust can include machine-readable instructions (e.g., firmware) of the controller, and system firmware (e.g., UEFI code). The startup of the computer system can include a boot process of the computer system as performed by the system firmware.

The machine-readable instructions include component information obtaining instructions 304 to, based on the validations of the components in the chain of trust and the manifest certificate, obtain information of a hardware or program component of the computer system. The obtained information can include information of a single hardware component, a singe program component, multiple hardware components, multiple program components, or multiple hardware and program components. The information obtained can include properties of any of the foregoing components.

The machine-readable instructions include update manifest population instructions 306 to include the obtained information of the hardware or program component in an update manifest certificate. The update manifest certificate can include a delta platform certificate or a rebase platform certificate, for example.

The machine-readable instructions include signed update manifest certificate obtaining instructions 308 to obtain a signed version of the update manifest certificate. The controller can itself sign the update manifest certificate, or the controller can request an operations management system to sign the update manifest certificate.

The machine-readable instructions include signed update manifest certificate storage instructions 310 to store the signed version of the update manifest certificate in a storage repository for establishing a trustworthiness of the computer system. The storage repository may be inside the computer system or outside the computer system.

In some examples, the obtained information included in the update manifest certificate includes information of an updated hardware or program component as updated by a system update enterprise after the computer system left a facility of a source of the computer system.

In some examples, the controller includes a hardware root of trust to initiate the validation of the components in the chain of trust.

In some examples, the components in the chain of trust include a component inventory module of system firmware of the computer system, and the component inventory module after validation is to collect the information of the hardware or program component to include in the update manifest certificate.

In some examples, the components in the chain of trust include machine-readable instructions of the controller.

In some examples, the controller can add information of a cryptographic anchor to the update manifest certificate. For example, the controller can add an EK to the update manifest certificate.

In some examples, the controller can halt a boot process of the computer system based on a determination that the information of the hardware or program component is available.

In some examples, the controller can validate the hardware or program component, and the controller obtains the information of the hardware or program component in response to validating the hardware or program component.

FIG. 4 is a block diagram of a computer system 400 according to some examples. The computer system 400 may be the computer system 102 of FIG. 1, for example.

The computer system 400 includes a management controller 402 to perform various tasks. The tasks of the management controller 402 may be performed by hardware processing circuitry of the management controller 402, or by machine-readable instructions executed by the management controller 402.

The tasks of the management controller 402 include a validation task 404 to, during a startup of the computer system, perform a validation of components in a chain of trust of the computer system, and a validation of a manifest certificate for the computer system. The manifest certificate validated may be a base platform certificate, for example.

The tasks of the management controller 402 include a component information obtaining task 406 to, based on the validations of the components in the chain of trust and the manifest certificate, obtain information of a hardware or program component of the computer system. The hardware or program component was updated by a system update enterprise different from a source of the computer system.

The tasks of the management controller 402 include an update manifest certificate population task 408 to include the obtained information of the hardware or program component in an update manifest certificate. The update manifest certificate may be populated with information of multiple hardware and/or program components.

The tasks of the management controller 402 include a cryptographic anchor information addition task 410 to include information of a cryptographic anchor in the update manifest certificate. The information of the cryptographic anchor can include an EK of a TPM, for example.

The tasks of the management controller 402 include an update manifest certificate signing task 412 to obtain a signed version of the update manifest certificate. The signed version of the update manifest certificate can be generated by the management controller 402, or by a different entity.

The tasks of the management controller 402 include a signed update manifest certificate storage task 414 to store the signed version of the update manifest certificate in a storage repository for establishing a trustworthiness of the computer system.

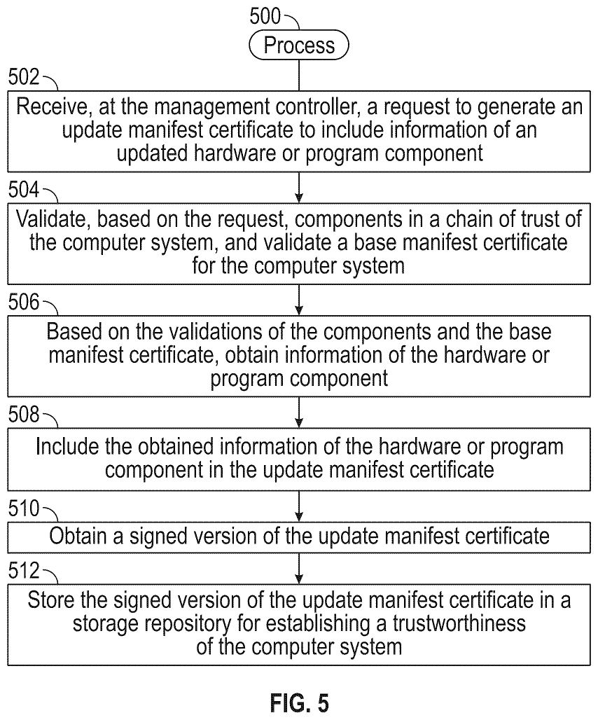

FIG. 5 is a flow diagram of a process 500 according to some examples. The process 500 may be performed by a management controller of a computer system.

The process 500 includes receiving (at 502), at the management controller, a request to generate an update manifest certificate to include information of an updated hardware or program component. The request may be from the system update enterprise device 104 of FIG. 1, for example.

The process 500 includes validating (at 504), based on the request, components in a chain of trust of the computer system, and validating a base manifest certificate for the computer system. The components in the chain of trust include machine-readable instructions of the management controller and system firmware.

Based on the validations of the components and the base manifest certificate, the process 500 includes obtaining (at 506) information of the hardware or program component. The obtained information can include properties of the hardware or program component.

The process 500 includes including (at 508) the obtained information of the hardware or program component in the update manifest certificate. The process 500 includes obtaining (at 510) a signed version of the update manifest certificate, and storing (at 512) the signed version of the update manifest certificate in a storage repository for establishing a trustworthiness of the computer system.

As used here, a “computer system” can refer to a desktop computer, a server computer, a notebook computer, a vehicle, a household appliance, or another type of electronic device. A “memory” can be implemented with one or more memory devices, such as a dynamic random access memory (DRAM) device, a static random access memory (SRAM) device, an erasable and programmable read-only memory (EPROM) device, an electrically erasable and programmable read-only memory (EEPROM) device, or a flash memory device.

A “storage device” can refer to a disk-based storage device or a solid-state drive. A “controller” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, a “controller” can refer to a combination of one or more hardware processing circuits and machine-readable instructions (software and/or firmware) executable on the one or more hardware processing circuits.

A hardware processor can include a microprocessor, a core of a multi-core microprocessor, a microcontroller, a programmable integrated circuit, a programmable gate array, or another hardware processing circuit.

A “BMC” can refer to a specialized service controller that monitors the physical state of a computer system using sensors and communicates with a remote management system (that is remote from the computer system) through an independent “out-of-band” connection. The BMC can perform management tasks to manage components of the computer system. Examples of management tasks that can be performed by the BMC can include any or some combination of the following: power control to perform power management of the computer system (such as to transition the computer system between different power consumption states in response to detected events), thermal monitoring and control of the computer system (such as to monitor temperatures of the computer system and to control thermal management states of the computer system), fan control of fans in the computer system, system health monitoring based on monitoring measurement data from various sensors of the computer system, remote access of the computer system (to access the computer system over a network, for example), remote reboot of the computer system (to trigger the computer system to reboot using a remote command), system setup and deployment of the computer system, system security to implement security procedures in the computer system, and so forth.

In some examples, the BMC can provide so-called “lights-out” functionality for the computer system. The lights out functionality may allow a user, such as a systems administrator, to perform management operations on the electronic device even if an OS is not installed or not functional on the computer system.

Moreover, in some examples, the BMC can run on auxiliary power provided by an auxiliary power source (e.g., 132 in FIG. 1); as a result, the computer system does not have to be powered on to allow the BMC to perform the BMC's operations. The auxiliary power source is separate from a primary power supply that supplies powers to other components (e.g., a main processor, a memory, an I/O device, etc.) of the computer system.

Although FIGS. 2 and 5 show processes including tasks in certain orders, in other examples, the tasks of the processes may be performed in a different order, some tasks may be omitted, and other tasks may be added.

A storage medium (e.g., 300 in FIG. 3) can include any or some combination of the following: a semiconductor memory device such as a DRAM or SRAM device, an EPROM device, an EEPROM device, or a flash memory device; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a controller of a computer system to:
during a startup of the computer system, perform a validation of components in a chain of trust of the computer system, and a validation of a manifest certificate for the computer system;
based on the validations of the components and the manifest certificate, obtain information of a hardware or program component of the computer system;
include the obtained information of the hardware or program component in an update manifest certificate;
obtain a signed version of the update manifest certificate; and
store the signed version of the update manifest certificate in a storage repository for establishing a trustworthiness of the computer system.

2. The non-transitory machine-readable storage medium of claim 1, wherein the obtained information comprises information of plural hardware or program components.

3. The non-transitory machine-readable storage medium of claim 1, wherein the obtained information included in the update manifest certificate includes information of an updated hardware or program component as updated by a system update enterprise after the computer system left a facility of a source of the computer system.

4. The non-transitory machine-readable storage medium of claim 1, wherein the controller comprises a hardware root of trust to initiate the validation of the components in the chain of trust.

5. The non-transitory machine-readable storage medium of claim 1, wherein the components in the chain of trust comprises a component inventory module of system firmware of the computer system, and wherein the component inventory module after validation is to collect the information of the hardware or program component to include in the update manifest certificate.

6. The non-transitory machine-readable storage medium of claim 1, wherein the components in the chain of trust comprise machine-readable instructions of the controller.

7. The non-transitory machine-readable storage medium of claim 1, wherein the instructions upon execution cause the controller to:
add information of a cryptographic anchor to the update manifest certificate.

8. The non-transitory machine-readable storage medium of claim 7, wherein the information of the cryptographic anchor comprises an endorsement key of a security processor.

9. The non-transitory machine-readable storage medium of claim 1, wherein the instructions upon execution cause the controller to:
halt a boot process of the computer system based on a determination that the information of the hardware or program component is available.

10. The non-transitory machine-readable storage medium of claim 1, wherein the instructions upon execution cause the controller to:
validate the hardware or program component,
wherein the obtaining of the information of the hardware or program component is responsive to validating the hardware or program component.

11. The non-transitory machine-readable storage medium of claim 1, wherein the instructions upon execution cause the controller to:
sign, using a private key, the update manifest certificate to obtain the signed version of the update manifest certificate.

12. The non-transitory machine-readable storage medium of claim 11, wherein the instructions upon execution cause the controller to:
generate a key pair comprising the private key and a public key corresponding to the private key.

13. The non-transitory machine-readable storage medium of claim 1, wherein the instructions upon execution cause the controller to:
send, in a secure communication session, the update manifest certificate to a management system to sign the update manifest certificate; and
receive, in the secure communication session, the signed version of the update manifest certificate from the management system.

14. The non-transitory machine-readable storage medium of claim 1, wherein the update manifest certificate comprises a delta platform certificate.

15. The non-transitory machine-readable storage medium of claim 1, wherein the update manifest certificate comprises a rebase platform certificate.

16. A computer system comprising:
a management controller to:
during a startup of the computer system, perform a validation of components in a chain of trust of the computer system, and a validation of a manifest certificate for the computer system;
based on the validations of the components and the manifest certificate, obtain information of a hardware or program component of the computer system, the hardware or program component updated by a system update enterprise different from a source of the computer system;
include the obtained information of the hardware or program component in an update manifest certificate;
include information of a cryptographic anchor in the update manifest certificate;
obtain a signed version of the update manifest certificate; and
store the signed version of the update manifest certificate in a storage repository for establishing a trustworthiness of the computer system.

17. The computer system of claim 16, further comprising:
a security processor,
wherein the information of the cryptographic anchor is useable to verify a binding of the update manifest certificate to the security processor.

18. The computer system of claim 17, wherein the information of the cryptographic anchor comprises an endorsement key, and wherein the security processor stores the endorsement key.

19. A method comprising:
receiving, at a management controller of a computer system, a request to generate an update manifest certificate to include information of an updated hardware or program component;
based on the request, validating, by the management controller, components in a chain of trust of the computer system, and validating a base manifest certificate for the computer system;
based on the validations of the components and the base manifest certificate, obtaining, by the management controller, information of the hardware or program component;
including, by the management controller, the obtained information of the hardware or program component in the update manifest certificate;
obtaining, by the management controller, a signed version of the update manifest certificate; and
storing, by the management controller, the signed version of the update manifest certificate in a storage repository for establishing a trustworthiness of the computer system.

20. The method of claim 19, wherein the update manifest certificate comprises a delta platform certificate or a rebase platform certificate.
